(19) United States
(12) Patent Application Publication
(10) Pub. No.: US 2024/0181546 A1
(43) Pub. Date: Jun. 6, 2024

(54) Reciprocating Saw Blade Having Teeth Formed of a Cemented Ceramic Material Welded to the Body of the Blade

(71) Applicant: Milwaukee Electric Tool Corporation, Brookfield, WI (US)

(72) Inventors: Max R. Sawa, Palatine, IL (US); Zachary D. Bernaden, Milwaukee, WI (US); Zachary J. Geschke, Milwaukee, WI (US); Eric A. Lembach, Wauwatosa, WI (US)

(21) Appl. No.: 18/440,559

(22) Filed: Feb. 13, 2024

Related U.S. Application Data
(63) Continuation of application No. PCT/US23/31745, filed on Aug. 31, 2023.
(60) Provisional application No. 63/374,303, filed on Sep. 1, 2022.

(51) Int. Cl. B23D 61/12; B23D 65/00

(52) U.S. Cl. CPC B23D 61/127; B23D 61/123; B23D 65/00

(57) ABSTRACT

Embodiments of the disclosure relate to a reciprocating saw blade. The reciprocating saw blade includes a body having a first end, a second end spatially disposed from the first end, a spine edge, and a cutting edge opposite to the spine edge. The reciprocating saw blade also includes a plurality of teeth defining a cutting portion of the cutting edge. Each tooth of the plurality of teeth includes a base having a unitary construction with the body. The base is made of a first material having a first hardness. A tip is welded to the base, and the tip is made of a cemented ceramic material having a second hardness that is greater than the first hardness. The cemented ceramic material includes tungsten carbide particles and at least 3 wt % of other particles including one or more cubic carbides.

### CROSS-REFERENCE TO RELATED PATENT APPLICATIONS

The present application is a continuation of International Application No. PCT/US2023/031745, filed Aug. 31, 2023, which claims the benefit of and priority to U.S. Application No. 63/374,303 filed on Sep. 1, 2022, each of which is incorporated herein by reference in its entirety.

### BACKGROUND

The present invention relates to a carbide tip for the teeth of a saw blade and, more particularly, to saw blades for use with power tools.

Saw blades, such as reciprocating saw blades, are used for cutting wood, metal, plastics, and other materials. A saw blade typically includes a body, one or more attachment portions, and a cutting portion. The cutting portion comprises a plurality of teeth that are raked back and forth over the work piece to cut through the material. Because of significant stresses associated with the cutting action, the teeth of reciprocating saw blades are prone to wearing out. The wear life of a saw blade can be improved by using harder and/or tougher materials for the teeth. Additionally or alternatively, the teeth may be coated to improve wear life. However, such improvements are balanced against the cost and feasibility of manufacturing the saw blade using improved materials.

### SUMMARY

According to an aspect, embodiments of the disclosure relate to a reciprocating saw blade. The reciprocating saw blade includes a body having a first end, a second end spatially disposed from the first end, a spine edge extending between the first end and the second end, and a cutting edge extending between the first end and the second end. The cutting edge is opposite to the spine edge. The reciprocating saw blade also includes a plurality of teeth defining a cutting portion of the cutting edge. Each tooth of the plurality of teeth includes a base having a unitary construction with the body. The base is made of a first material having a first hardness. A tip is welded to the base, and the tip is made of a cemented ceramic material having a second hardness. The second hardness is greater than the first hardness. The cemented ceramic material includes tungsten carbide particles and other ceramic particles held together with a metal matrix material. The other ceramic particles are made of at least one ceramic material having a hardness of at least 1500 HV10 and a thermal conductivity of 50 W/mK or less.

According to another aspect, embodiments of the disclosure relate to a reciprocating saw blade. The reciprocating saw blade includes a body having a first end, a second end spatially disposed from the first end, a spine edge extending between the first end and the second end, and a cutting edge extending between the first end and the second end. The cutting edge is opposite to the spine edge. The reciprocating saw blade also includes a plurality of teeth defining a cutting portion of the cutting edge. Each tooth of the plurality of teeth includes a base having a unitary construction with the body. The base is made of a first material having a first hardness. A tip is welded to the base, and the tip is made of a cemented ceramic material having a second hardness. The second hardness is greater than the first hardness. The cemented ceramic material includes tungsten carbide particles and other particles including one or more cubic carbides. The tungsten carbide particles and the other particles are held together with a metal matrix material. The cemented ceramic material includes at least 3 wt % of the other particles including the one or more cubic carbides.

According to still another aspect, embodiments of the disclosure relate to a reciprocating saw blade. The reciprocating saw blade includes a body having a first end, a second end spatially disposed from the first end, a spine edge extending between the first end and the second end, and a cutting edge extending between the first end and the second end. The cutting edge is opposite to the spine edge. The reciprocating saw blade also includes a plurality of teeth defining a cutting portion of the cutting edge. Each tooth of the plurality of teeth includes a base having a unitary construction with the body. The base is made of a first material having a first hardness. A tip is welded to the base, and the tip is made of a cemented ceramic material having a second hardness. The second hardness is greater than the first hardness. The cemented ceramic material includes tungsten carbide particles and other particles including one or more ceramic materials. The tungsten carbide particles and the other particles are held together with a metal matrix material. The cemented ceramic material has a hardness of at least 1000 HV10 at room temperature.

According to a further aspect, embodiments of the disclosure relate to a cutting implement. The cutting implement includes a body having a cutting edge. The cutting implement further includes a plurality of teeth defining a cutting portion of the cutting edge. The plurality of teeth include at least four teeth per inch. Each tooth of the plurality of teeth includes a base having a unitary construction with the body. The base is made of a first material having a first hardness. A tip is welded to the base, and the tip is made of a cemented ceramic material having a second hardness. The second hardness is greater than the first hardness. The cemented ceramic material includes tungsten carbide particles and other particles including one or more ceramic materials. The tungsten carbide particles and the other particles are held together with a metal matrix material. The cemented ceramic material has a hardness of at least 1000 HV10 at room temperature.

According to still a further aspect, embodiments of the disclosure relate to a method of joining tips made of a cemented ceramic material to a body of a reciprocating saw blade to form a plurality of teeth. In the method, inserts of the cemented ceramic material are pressed against respective bases of the plurality of teeth. The bases are of unitary construction with the body of the reciprocating saw blade. The inserts are welded to the respective bases of the plurality of teeth. The plurality of teeth are ground to form tips from the inserts. The cemented ceramic material includes tungsten carbide particles and other particles including one or more cubic carbides. The tungsten carbide particles and the other particles are held together with a metal matrix material. The cemented ceramic material includes at least 3 wt % of the one or more cubic carbides.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a reciprocating saw blade and an associated reciprocating saw, according to an exemplary embodiment;

FIG. 2 depicts the reciprocating saw shown in FIG. 1, according to an exemplary embodiment;

FIG. 3 depicts a detail view of a cutting portion of the reciprocating saw of FIG. 2, according to an exemplary embodiment;

FIG. 4 depicts a detail view of cutting teeth of the cutting portion of FIG. 3, according to an exemplary embodiment;

FIG. 5 depicts a flow diagram of a method for attaching cemented ceramic tips to the teeth of a reciprocating saw, including optional steps of edge prep and thin film coating, according to an exemplary embodiment;

FIG. 6 depicts a thin film ceramic coating on a tip of a cutting tooth, according to an exemplary embodiment;

FIG. 7 depicts another reciprocating saw blade, according to another exemplary embodiment;

FIG. 8 depicts an embodiment of an oscillating saw blade that can include teeth formed of the cemented ceramic material, according to an exemplary embodiment; and

FIG. 9 depicts an embodiment of a hole saw that can include teeth formed of the cemented ceramic material, according to an exemplary embodiment.

### DETAILED DESCRIPTION

Referring generally to the figures and to following discussion, various embodiments of a reciprocating saw blade having teeth with welded cemented ceramic tips are disclosed herein. As will be described more fully below, the cemented ceramic tips are formed from tungsten carbide and other ceramic particles, in particular cubic carbides, having a high hardness at operating temperature. Tungsten carbide is used in cemented carbide applications because of its high room temperature hardness, exceptional wear resistance, and ability to be welded to steel blade bodies. However, other ceramic materials, such as cubic carbides, have superior hardness at operating temperatures. To date, their use for various applications is limited by their low thermal conductivity, which increases the difficulty of joining these materials to a blade body. Instead of welding, cemented carbides including cubic carbides are conventionally brazed to the blade body or mechanically fastened to a cutting tool. Brazing, though, is not economical or feasible in applications where the blade body has many, small joint interfaces, such as in reciprocating saw blades. Additionally, the small size of the teeth and thinness of the blade makes mechanical fastening unfeasible. The low thermal conductivity would also create mismatches in thermal expansion characteristics within each tooth and between the teeth and the blade body

Because of the reduced weldability and because brazing and mechanical fastening are not feasible, cubic carbides have not been incorporated into reciprocating saw blades or other similar blades having many, small joint interfaces, such as hole saws and oscillating saw blades. Despite the expected joining difficulties in using cubic carbides in these particular applications, the inventors have surprisingly and unexpectedly found that teeth formed of the cemented ceramic material that includes tungsten carbides and cubic carbides can be satisfactorily and economically welded to the blade body of reciprocating saw blades. Reciprocating saw blades having teeth with tips formed from such cemented ceramic material have been shown to exhibit higher hardness at operating temperature, increased wear life, and faster cutting over the life of the blade. These and other aspects and advantages of the welded cemented ceramic tips for teeth of reciprocating saw blades will be discussed in relation to the embodiments provided below and shown in the accompanying drawings. These embodiments are presented by way of illustration and not limitation.

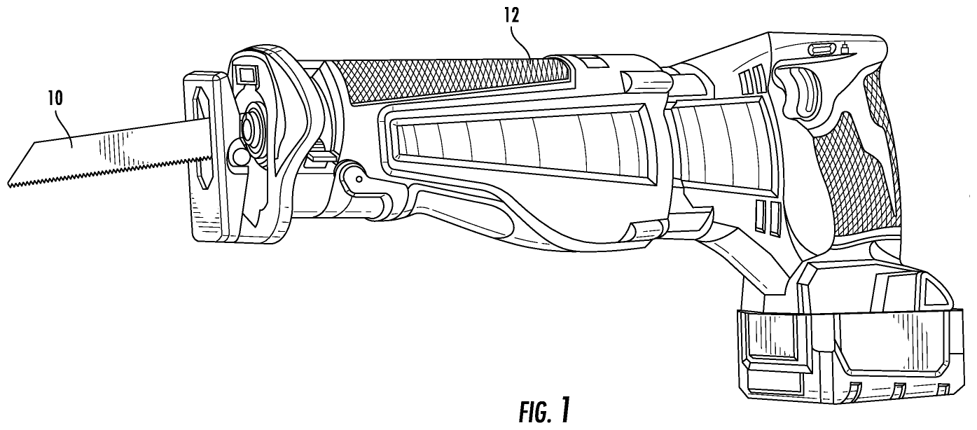

Embodiments of the present disclosure relate to a reciprocating saw blade 10 for a reciprocating saw 12. FIG. 1 illustrates an embodiment of a reciprocating saw 12 including an embodiment of the reciprocating saw blade 10 according to the present disclosure. In one or more embodiments, the reciprocating saw blade 10 is configured to be reversibly coupled to the reciprocating saw 12. For example, the reciprocating saw 12 can be used with a variety of different reciprocating saw blades 10, e.g., configured to cut through different materials. Additionally, as reciprocating saw blades 10 wear out, the worn reciprocating saw blades can be replaced with new reciprocating saw blades 10. In one or more embodiments, the reciprocating saw 12 is a power tool configured to work using an electrical power supply, such as a battery or a power cord.

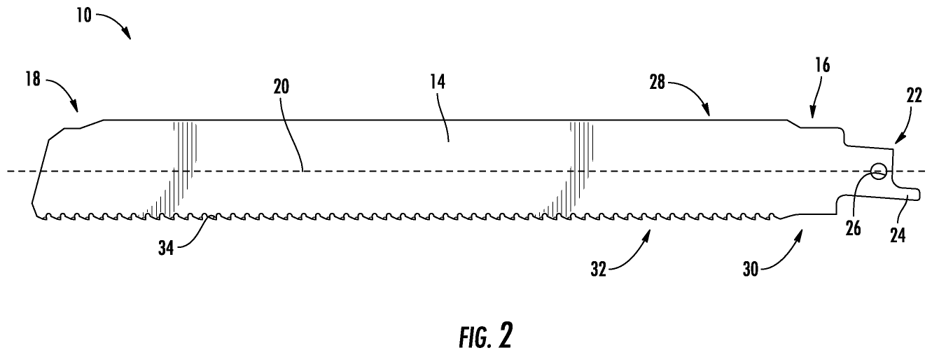

FIG. 2 illustrates an embodiment of a reciprocating saw blade 10 according to the present disclosure. The reciprocating saw blade 10 includes a body 14 having a first end 16 and a second end 18. The first end 16 is spatially disposed from the second end 18 along a longitudinal axis 20 of the reciprocating saw blade 10. In one or more embodiments, the first end 16 includes an attachment portion 22 that is coupled to the body 14. In one or more such embodiments, the attachment portion 22 includes a tang 24 and an aperture 26 for coupling the reciprocating saw blade 10 to the reciprocating saw 12 (as shown in FIG. 1). In one or more other such embodiments, the attachment portion 22 may include other suitable structures for coupling the reciprocating saw blade 10 to the reciprocating saw 12. In one or more embodiments, the body 14 of the reciprocating saw blade 10 is formed, for example, from coil stock via stamping, laser cutting, grinding, or the like. In one or more embodiments, the body 14 of the reciprocating saw blade 10 is formed from a steel alloy. In one or more embodiments, the steel alloy for the body 14 can be selected from a variety of suitable steel alloys from relatively inexpensive AISI 1018 steel to relatively more expensive D6a HSS. A particular example of a steel alloy usable for the body 14 is AISI 6150 having a hardness in the range of 40 HRC to 55 HRC (Rockwell C hardness).

The reciprocating saw blade 10 includes a spine edge 28 and a cutting edge 30 with the cutting edge 30 being opposite to the spine edge 28. The spine edge 28 and the cutting edge 30 each extend between the first end 16 and the second end 18. The cutting edge 30 includes a cutting portion 32 comprising a plurality of cutting teeth 34. In one or more embodiments, the cutting teeth 34 form a linear cutting edge 30 on the body 14. In one or more other embodiments, the cutting edge 30 is non-linear (e.g., curved, angled, discontinuous, etc.).

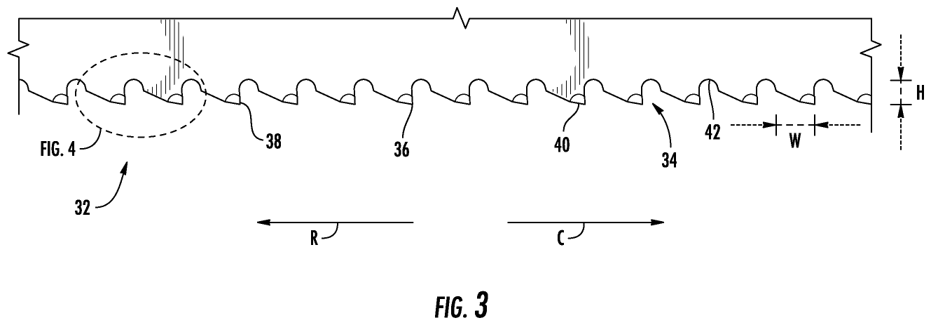

In one or more embodiments, including the embodiment illustrated in FIG. 2, each tooth 34 is generally the same shape and size. In one or more other embodiments, the shape and/or size of the teeth 34 may vary along the length of the cutting portion 32. As shown in FIG. 3, each tooth 34 includes a point 36, a rake face 38, and a relief face 40. Further, the cutting teeth 34 are separated from each other by a plurality of gullets 42. In one or more embodiments, the points 36 of the cutting teeth 34 define a plane that is generally parallel to the longitudinal axis 20 of the reciprocating saw blade 10 (as shown in FIG. 2). Each tooth 34 has a width W measured in a direction generally parallel to the longitudinal axis 20 of the body 14. The width W extends from the rake face 38 to an opposite end of the relief face 40. Each tooth 34 also has a height H measured in a direction generally perpendicular to longitudinal axis 20 of the body 14. The height H extends from the point 36 to a base of the corresponding gullet 42. During operation, the reciprocating saw blade 10 is reciprocated in a cutting direction C and a return direction R to cut through a work piece.

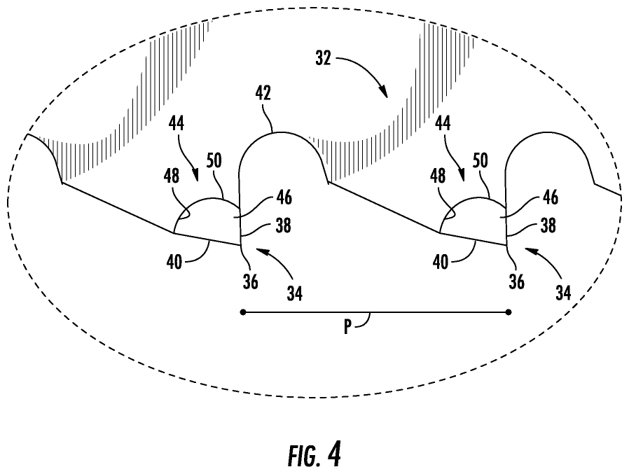

With reference to FIG. 4, each tooth 34 is spaced a pitch P from an adjacent tooth 34. The pitch P is measured between points 36 of adjacent teeth 34. In one or more embodiments, including the embodiment illustrated, the pitch P of the cutting teeth 34 is approximately the same along the length of the cutting portion 32. In one or more other embodiments, the pitch P varies between adjacent teeth 34. In one or more embodiments, the pitch P is such that the cutting portion 32 includes five teeth per inch (TPI), i.e., adjacent cutting teeth 50 are separated by a pitch P of 0.2 inches. In one or more other embodiments, the cutting portion 32 may include fewer or more teeth per inch. For example, the cutting portion 32 may include 4 TPI, 6 TPI, or the like.

In one or more embodiments, the blade body 14 of the reciprocating saw blade 10 is comprised of a first material (e.g., low-carbon steel, high speed steel, tool steel, or high strength, low alloy steel), and each cutting tooth 34 is comprised in part of the first material having a first hardness and in part of a second material having a second hardness greater than the first hardness. In particular, as shown in FIG. 4, each cutting tooth 34 includes base 44 and a tip 46. The base 44 and the tip 46 together form part the relief face 38 and rake face 40 of the tooth 34, and the tip 46 forms the point 36 of tooth 34. In one or more embodiments, the base 44 is of unitary construction with the blade body 14 and is comprised of the first material, and the tip 46 is formed from an insert of the second material joined to the base 44. In one or more embodiments, the base 44 includes a first mating surface 48, and the tip 46 includes a second mating surface 50 configured to engage the first mating surface 48. In one or more embodiments, included the embodiment depicted in FIG. 4, the first mating surface 48 is concave, and the second mating surface 50 is convex. As will be discussed more fully below, inserts forming the tip 46 are positioned adjacent to the base 44 and are welded together. Thereafter, the inserts are machined to form the cutting surface of the tooth 34.

According to the present disclosure, the second material forming the tips 46 of the teeth 34 is a cemented ceramic including tungsten carbide particles as well as various other hard ceramic particles in a metallic matrix. In particular, the cemented ceramic includes tungsten carbide in an amount of at least 50 wt %, in particular 50 wt % to 80 wt %.

In one or more embodiments, at least some of the ceramic particles are formed from a ceramic material having a hardness of at least 1500 HV10 (Vickers hardness). In or more embodiments, at least some of the ceramic particles are formed from a ceramic material having a hardness of up to 3200 HV10.

In one or more embodiments, at least some of the ceramic particles are formed from a ceramic material having a thermal conductivity of 90 W/mK or less, in particular 50 W/mK or less, and particularly 30 W/mK or less. In one or more embodiments, at least some of the ceramic particles are formed from a ceramic material having a thermal conductivity of at least 5 W/mK, in particular at least 10 W/mK.

In one or more embodiments, the ceramic particles include cubic carbides. In one or more embodiments, the cubic carbides include titanium carbide (TIC), tantalum carbide (TaC), niobium carbide (NbC), zirconium carbide (ZrC), hafnium carbide (HfC), and vanadium carbide (VC). Such cubic carbides have a face-centered cubic (fcc) or gamma phase structure. In one or more embodiments, the cemented ceramic includes at least 1 wt %, at least 3 wt %, or at least 10 wt % of cubic carbides. In one or more embodiments, the cemented ceramic includes up to 30 wt %, up to 35 wt %, or up to 55 wt % of cubic carbides. In one or more embodiments, the cubic carbides include TiC in an amount up to 55 wt %, more particularly up to 35 wt %, and most particularly in an amount up to 20 wt %. In one or more embodiments, the cubic carbides include TiC in an amount of at least 1 wt %, more particularly in an amount of at least 2 wt %, and most particularly at least 5 wt %. In one or more embodiments, the cubic carbides include TaC in an amount up to 55 wt %, more particularly up to 35 wt %, and most particularly in an amount up to 20 wt %. In one or more embodiments, the cubic carbides include TaC in an amount of at least 0.5 wt %, more particularly at least 1 wt %, and most particularly at least 2 wt %. In one or more embodiments, the cubic carbides include NbC in an amount up to 55 wt %, more particularly up to 35 wt %, and most particularly an amount up to 20 wt %. In one or more embodiments, the cubic carbides include NbC in an amount of at least 1 wt %, more particularly an amount of at least 2 wt %, and most particularly at least 5 wt %.

In one or more embodiments, the ceramic particles include other hard particles besides tungsten carbide and cubic carbides. In one or more embodiments, the other hard particles have a particle hardness that is at least 1000 HV10. In one or more embodiments, the hard particles are selected from among nitrides or borides. In one or more embodiments, the nitrides include titanium nitride (TiN), binary and ternary nitrides, transition metal nitrides, and high entropy nitrides.

The tungsten carbide and other ceramic particles are cemented together with a metal matrix material. In one or more embodiments, the metal matrix material comprises at least one of cobalt, nickel, or iron. In one or more embodiments, the cemented ceramic includes from 3 wt % to 25 wt %, in particular 6 wt % to 15 wt %, of the metal matrix material. For example, in one or more embodiments, the cemented ceramic includes from 3 wt % to 25 wt %, in particular 6 wt % to 15 wt %, of at least one of cobalt, nickel, or iron.

In one or more embodiments, the metal or metals used in the metal matrix material have a thermal conductivity of at least 75 W/mK, in particular at least 85 W/mK, and most particularly at least 90 W/mK. For example, cobalt has a thermal conductivity of about 100 W/mK, nickel has a thermal conductivity of about 97.5 w/mK, and iron has a thermal conductivity of about 80 W/mK.

In one or more embodiments, the metal or metals used in the metal matrix material have a hardness of at least 50 HV10, at least 100 HV10, or at least 125 HV10. For example, the hardness of cobalt is in the range of about 140 to 240 HV10, the hardness of nickel is about 65 HV10, and the hardness of iron is about 150 HV10. The hardness of the metal matrix material as incorporated into the cemented ceramic will generally be harder than the individual metals making up the metal matrix material because of the tungsten carbide and other hard ceramic particles. In particular, the hardness of the metal matrix material depends on the mean free path within the metal matrix material, which corresponds to the average width of the matrix material between the tungsten carbide and other hard ceramic particles. A smaller width of the metal matrix material between the tungsten carbide and other hard ceramic particles leads to a higher hardness. Further, the metal matrix material will typically be harder than the individual metals making up the metal matrix material because of some tungsten and carbon will be in solution with the metal matrix material.

In one or more embodiments, the cemented ceramic formed of the tungsten carbide, ceramic particles, and metal matrix material described above, has a grain size of 0.5 μm to 5 μm, in particular 1 μm to 1.3 μm. In one or more embodiments, the grain size is measured according to ISO 4499-2. In one or more embodiments, the cemented ceramic has a hardness of at least 1000 HV10 at room temperature. In one or more embodiments, the cemented ceramic has a hardness of up to 1800 HV10 at room temperature. In one or more embodiments, the cemented ceramic has a hardness in the range of 1300 HV10 to 1400 HV10 at room temperature.

Certain conventional reciprocating saw blades may have teeth including cemented tungsten carbide tips. Such cemented tungsten carbide tips may also possess a room temperature hardness of 1000 HV 10 or greater. However, the room temperature hardness of any such cemented tungsten carbides is not maintained at the temperatures associated with cutting, especially with cutting a tough material like cast iron. It is believed that the cemented tungsten carbide tips experience a significant decrease in hardness at operating temperatures, and accordingly, such cemented tungsten carbide blades may not exhibit a long wear life as compared to the disclosed reciprocating saw blades having cemented ceramic tips. The wear resistance of a reciprocating saw blade can be quantified based on the speed or life (number of cuts) in a given material (e.g., cast iron pipe) under specified work instructions (such as time between cuts, tool model number for making the cuts, etc.). According to wear resistance tests carried out by the inventors, reciprocating saw blades having tips 46 made from the disclosed cemented ceramic material have performed over twice as well as conventional tungsten carbide tipped reciprocating saw blades. The inventors surmise that the better performance results from the incorporation of cubic carbides into the tip of 46 of the reciprocating saw blade 10. Without wishing to be bound by theory, such cubic carbides are believed to possess a higher hardness than tungsten carbides at the temperatures developed at the teeth 34 during cutting. Although, such cubic carbides are also believed to have a lower fracture toughness, and thus, the reciprocating saw blades 10 according to the present disclosure are able to perform better under wear resistance testing by balancing higher high temperature hardness against lower fracture toughness.

Table 1 provides an example composition of a cemented ceramic usable as tips 46 of teeth 34 of a reciprocating saw blade 10 according to the present disclosure. As can be seen from Table 1, the largest constituent (61 wt %) of the cemented carbide tip is tungsten carbide (WC), which has a thermal conductivity of about 120 W/mK and a room temperature hardness of about 2345 HV10. Additionally, the tungsten carbide has a hexagonal close packed structure. The cemented ceramic also includes hard ceramic particles of titanium carbide (TIC), tantalum carbide (TaC), and niobium carbide (NbC). These carbides have a face-centered cubic (fcc) structure and have a thermal conductivity that is much lower than tungsten carbide. In particular, these carbides have a thermal conductivity of less than 30 W/mK. The cobalt (Co) and nickel (Ni) form the metal matrix material cementing the tungsten carbide and ceramic particles together. These metals also have a thermal conductivity of around 100 W/mK.

TABLE 1
Example Composition of Cemented Ceramic

| | | Thermal Conductivity | Hardness |
|---|---|---|---|
| Component | Wt % | (W/mK) | (HV10) |
| WC | Bal. | 120 | 2345 |
| TiC | 12 | 21 | 2855 |
| TaC | 2 | 27.9 | 1631 |
| NbC | 11 | 27 | 1835 |
| Co | 9 | 100 | 140-240 |
| Ni | 5 | 97.5 | 65 |
| TiC + TaC + NbC | 25 | — | — |
| Co + Ni | 14 | — | — |

Thus, the cemented ceramic material is predominantly (75 wt %) made of materials having a relatively high thermal conductivity of about 100 W/mK or higher. The added ceramic particles, in particular the fcc carbides (25 wt %), have a much lower thermal conductivity. This makes the process of joining the cemented ceramic tip 46 to the base 44 difficult using a welding process.

In particular, reciprocating saw blades 10 have several small teeth 34 in comparison to other types of blades (such as circular saw blades). The small size of the tip 46 and base 44 of each tooth 34 as well as the thinness of the reciprocating saw blade body 14 can create an issue of distortion and burnthrough during joining, which is exacerbated by the low thermal conductivity and higher melting temperature of the cubic carbides in the cemented ceramic material. In conventional cemented tungsten carbide tips, the tungsten carbide melts or dissolves at the interface between the base (typically a steel alloy) and the tip, allowing for mixing of the tungsten carbide and the steel of the base. However, the other ceramic particles, especially the fcc carbides, do not mix or do not mix significantly at the interface between the tip 46 and the base 44. In other contexts, this issue might be addressed by brazing the tip 46 to the base 44, which involves joining the tip 46 to the base 44 using a layer of molten brazing material, but brazing is not a satisfactory solution for reciprocating saw blades because, again, the large number of small teeth 34 makes brazing impractical and uneconomical.

Despite the issues associated with thermal joining, the inventors surprisingly and unexpectedly found that the cemented ceramic tips 46 could be welded to the respective bases 44 of the teeth 34. That is, despite the low thermal conductivity of the ceramic particles, especially the fcc carbides (TiC, TaC, NbC), which dictated against using welding to join the tips 46 to the bases 44 of the teeth 34, the inventors found that welding could nevertheless provide an economical and effective way to join the cemented ceramic tips 46 to the body 14 of the reciprocating saw blade 10. In particular and as opposed to a braze joint or mechanical joint, the weld creates a metallurgical bond between the cemented ceramic tips 46 and the bases 44 of the body 14. Further, the welding creates a zone of diffusion in which the cemented ceramic, in particular the metal matrix, diffuses into the body 14 of the reciprocating saw blade, and e.g., the iron of the steel alloy of the body 14 diffuses into the cemented ceramic.

In one or more embodiments, the cemented ceramic is formed by sintering powders of the metal matrix material, the tungsten carbide, and the ceramic particles into an insert for joining to the base 44 of a tooth 34 of the reciprocating saw blade 10. In one or more embodiments, the inclusion of trace amounts (≤0.5 wt %) of additional cubic carbides (such as VC, NbC, or TaC) during sintering can inhibit the growth of the tungsten carbide grains, providing a fine or ultrafine grain size. In one or more embodiments, the inserts are coated with nickel to enhance wettability during welding and to create a diffusion barrier of the carbides into the bases 44 of the teeth 34. In one or more embodiments, the nickel coating has a thickness of 8 μm to 25 μm.

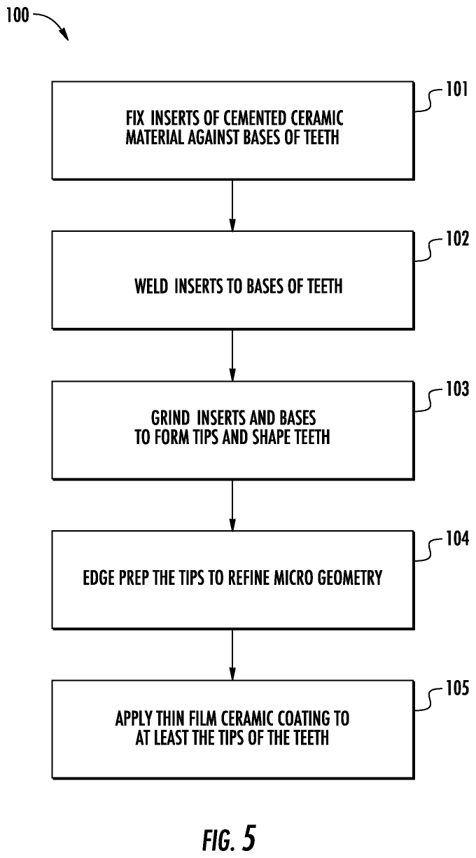

In preparing the reciprocating saw blade 10, one insert is provided for each base 44. As shown in FIG. 4, the base 44 has a concave shape that matches the curvature of a cylindrical insert. However, other in one or more other embodiments, the base 44 and insert may have different, complementary shapes, including other rounded or angled shapes. According to one or more embodiments of a method 100 for forming the teeth 34 of the reciprocating saw blade 10 as shown in FIG. 5, a first step 101 involves fixing inserts of the cemented ceramic against each base 44 of the reciprocating saw blade 10. Thereafter, in a second step 102, the inserts are welded to the bases 44 of the teeth 34 by heating until a melt interface is created through which the inserts are joined to the bases 44. After welding, the volume of the insert may be reduced because of diffusion of the cemented ceramic into the material of the body 14. In one or more embodiments, the material of the body 14 may diffuse through up to half of the volume of the insert. In a third step 103, the inserts and bases 44 are ground to form the tips 46 and shape the teeth 34. Thereafter, the teeth 34 are set to create the desired kerf. Additionally, the reciprocating saw blade 10 may be heat treated to provide desired properties of the body 14.

In one or more embodiments, the method 100 optionally involves a fourth step 104 in which the inserts and bases 44 are edge prepped, which includes removing sharp edges, corners, and weld pools from the substrate 44. Particularly, edge prepping refines the micro geometry of the cutting teeth 34 of the reciprocating saw blade 10. As a result of edge prepping, the amount of stress risers and blunts on the cutting edge of each tooth 34 is reduced. Stress risers are peaks that are inadvertently developed during the manufacturing process of the reciprocating saw blade 10. The stress risers amplify stress during machining, thereby decreasing the lifespan of the reciprocating saw blade 10. Similarly, a sharp cutting edge creates a lever that may convert force during cutting into tensile stress on the reciprocating saw blade 10. These additional stresses may cause the cemented ceramic tip 46 to fracture, compromising the integrity of the cemented ceramic tip 46 and/or exposing the cemented ceramic tip 46. In one or more other embodiments, the cemented ceramic tip 46 may not be edge prepped.

In one or more embodiments, the method 100 further includes an optional fifth step 105 of coating the teeth 34 with a thin film ceramic coating. In one or more embodiments, the coating is selected from nitride coatings. In one or more embodiments, the nitride coatings contain one or more of aluminum, titanium, chromium, or molybdenum. In one or more embodiments, the coating is selected from among aluminum titanium nitride (AlTiN), aluminum chromium nitride (AlCrN), aluminum titanium chromium nitride (AlTiCrN), or titanium molybdenum nitride (TiMoN), amongst other possibilities. In one or more embodiments, the thin film ceramic coating is applied using chemical vapor deposition or physical vapor deposition (e.g., evaporation or sputtering), amongst other possibilities. Physical vapor deposition techniques are particularly preferred because they typically do not require high temperatures that may affect the desired properties of the reciprocating saw blade 10. In one or more embodiments, the coating is applied to solely the cemented ceramic tip 46. In one or more other embodiments, the coating is applied to each tooth 34 including the tip 46 and base 44, but not including the body 14 of the reciprocating saw blade 10 outside of the base 44. In still one or more other embodiments, the coating is applied to the entire cutting portion 32, but not including the body 14 of the reciprocating saw blade 10. In yet one or more other embodiments, the coating is applied to the entirety of the reciprocating saw blade 10, including the body 14.

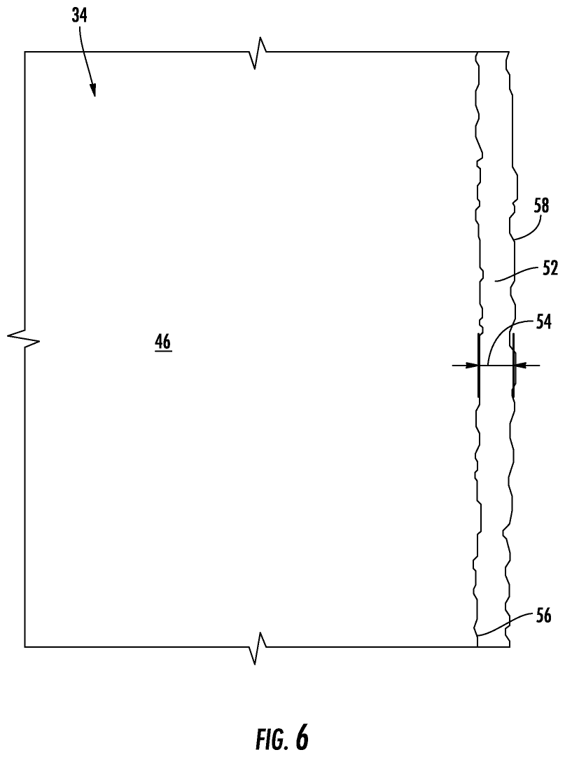

FIG. 6 depicts an embodiment of a thin film ceramic coating 52 applied to a tooth 34, in particular to the cemented ceramic tip 46. As mentioned, the coating 52 may be any one of a variety of coatings, particularly nitride coatings applied via physical vapor deposition. The coating 52 may be selected to enhance performance in a particular context. For example, a coating 52 of AlTiN increases hardness as a result of micro-structure changes and solid solution hardening. Further, a coating 52 of AlTiN age hardens at operating temperatures, thereby increasing in hardness over the life of the reciprocating saw blade 10. A coating of AlCrN provides high hardness and high wear resistance under extreme mechanical stresses, such as in high-speed applications. A coating of AlTiCrN provides high hardness, high toughness, and high oxidation temperature, which may be useful for cutting stainless steels, superalloys, and other difficult to cut materials. As mentioned, other coatings 52 may also be used, such as TiMON, amongst others.

In one or more embodiments, the coating 52 has a thickness 54 measured between an outer surface 56 of the cemented ceramic tip 46 (or cutting tooth 34) and an outer surface 58 of the coating 52. In one or more embodiments, the thickness 54 of the coating 52 is at least 2 μm. In one or more embodiments, the thickness 54 of the coating 52 is at least 3 μm. In one or more embodiments, the thickness 54 of the coating 52 is from 2 to 5 μm. In one or more embodiments, the thickness 54 of the coating 52 is from 3 to 4 μm. In one or more embodiments, the thickness 54 of the coating 52 is about 3.5 μm.

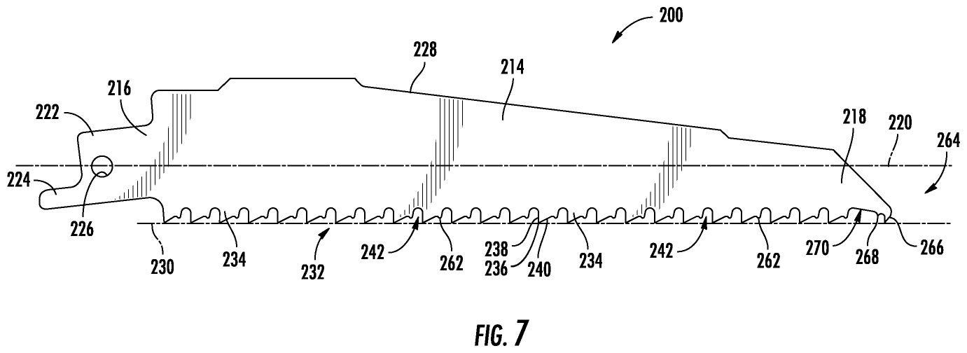

The embodiment of the reciprocating saw blade 10 shown in FIGS. 1-4 is merely exemplary, and the cemented ceramic tips can be provided on cutting teeth of other styles of reciprocating saw blades, such as the reciprocating saw blade 200 shown in FIG. 7.

The reciprocating saw blade 200 includes a body 214 with a first end 216 spatially disposed from a second end 218 along a longitudinal axis 220 of the reciprocating saw blade 200. An attachment portion 222 for coupling the reciprocating saw blade 200 to a reciprocating saw is connected to the body 214 at the first end 216. The body 214 includes a spine edge 228 and a cutting edge 230 opposite to the spine edge 228. The cutting edge 230 includes a cutting portion 232 having a plurality of cutting teeth 234.

The cutting teeth 234 include points 236, a rake face 238, and a relief face 240 and are separated by a gullet 242. The gullet 242 of each cutting tooth 234 extends between the rake face 238 and a protrusion 262 of an adjacent tooth 234. The relief face 240 of each cutting tooth 234 terminates at the beginning of the protrusion 262. In one or more embodiments, each protrusion 262 is curved such that the protrusions 262 are generally rounded. In one or more other embodiments, the protrusions 262 may have other shapes or forms. In one or more embodiments, the reciprocating saw blade 200 may be used to cut through work pieces composed of wood having nails extending through or embedded therein, and the protrusions 262 help inhibit nails from entering the gullets 242 of the cutting teeth 234 during cutting operations.

Further, in one or more embodiments, the reciprocating saw blade 200 includes a plunge point 264 for initiating a plunge cut. The plunge point 264 is formed on the second end 218 of the body 214 opposite the attachment portion 222. In one or more embodiments, the plunge point 264 includes a leading tooth 266 and a second tooth 268. The leading tooth 266 and second tooth 268 are separated from the other cutting teeth 234 of the cutting portion 232 by a leading gullet 270, which spans a larger distance than that of the gullets 242 between the cutting teeth 234.

The leading tooth 266 is shaped such that the leading tooth 266 is able to penetrate the workpiece without hooking or grabbing the material being cut, allowing the plunge point 264 to more easily penetrate a work piece without chipping the work piece. The second tooth 268 improves plunge cut performance by breaking up chip material, thereby reducing the load on the leading tooth 266 and facilitating chip removal. Such an arrangement also increases cutting speed and saw blade life. In one or more embodiments, the plunge point 264 includes a single second tooth 268 prior to the leading gullet 270. In one or more other embodiments, the plunge point 264 includes multiple second teeth 268 positioned prior to the leading gullet 270. In one or more other embodiments, the second tooth 268 is omitted from the plunge point 264.

The cutting teeth 234, the leading tooth 266, and the second tooth 268 of the reciprocating saw blade 200 may include tips of the cemented ceramic material welded to bases of the teeth 234 as described above.

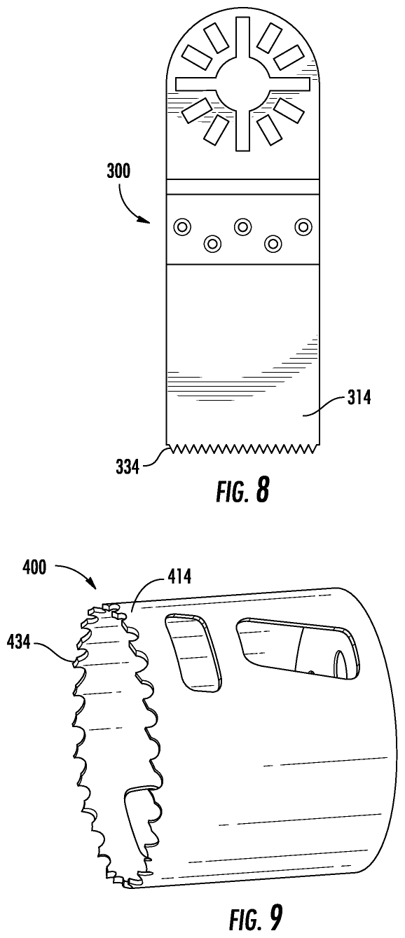

Other cutting implements having a plurality of small, relatively closely spaced teeth (e.g., having at least four teeth per inch) may also be prepared by welding the cemented ceramic material to the body of the cutting implement. Examples of other cutting implements include an oscillating saw blade 300 as shown in FIG. 8 and hole saw 400 as shown in FIG. 9. In one or more embodiments, the oscillating saw blade 300 and the hole saw 400 have respective teeth 334, 434 formed with tips of the cemented ceramic material welded to the respective bodies 314, 414. As with the disclosed embodiments of the reciprocating saw blades 10, 200, it is expected that the usable life and cutting performance of the oscillating saw blade 300 and the hole saw 400 will be improved by including the welded tips of the cemented ceramic material disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A reciprocating saw blade, comprising:
a body comprising a first end, a second end spatially disposed from the first end, a spine edge extending between the first end and the second end, and a cutting edge extending between the first end and the second end, the cutting edge being opposite to the spine edge;
a plurality of teeth defining a cutting portion of the cutting edge;
wherein each tooth of the plurality of teeth comprises:
a base having a unitary construction with the body, the base comprising a first material having a first hardness;
a tip welded to the base, the tip comprising a cemented ceramic material having a second hardness, the second hardness being greater than the first hardness;
wherein the cemented ceramic material comprises tungsten carbide particles and other particles comprising one or more cubic carbides, the tungsten carbide particles and the other particles being held together with a metal matrix material;
wherein the cemented ceramic material comprises at least 3 wt % of the other particles comprising the one or more cubic carbides.

2. The reciprocating saw blade of claim 1, wherein the one or more cubic carbides comprise cubic carbides having a hardness of at least 1500 HV10 and a thermal conductivity of 50 W/mK or less

3. The reciprocating saw blade of claim 1, wherein the one or more cubic carbides comprise at least one of titanium carbide (TiC), tantalum carbide (TaC), niobium carbide (NbC), zirconium carbide (ZrC), hafnium carbide (HfC), and vanadium carbide (VC).

4. The reciprocating saw blade of claim 1, wherein the other particles comprising the one or more cubic carbides comprise up to 55 wt % of the cemented ceramic material.

5. The reciprocating saw blade of claim 4, wherein cemented ceramic material comprises up to 55 wt % of at least one of TiC, TaC, or NbC.

6. The reciprocating saw blade of claim 5, wherein the cemented ceramic material comprises about 12 wt % TiC, about 2 wt % TaC, and about 11 wt % NbC.

7. The reciprocating saw blade of claim 1, wherein the cemented ceramic material comprises at least 50 wt % of the tungsten carbide particles.

8. The reciprocating saw blade of claim 7, wherein the cemented ceramic material comprises about 61 wt % of the tungsten carbide particles.

9. The reciprocating saw blade of claim 1, wherein the cemented ceramic material comprises from 3 wt % to 25 wt % of the metal matrix material.

10. The reciprocating saw blade of claim 1, wherein the metal matrix material comprises at least one of cobalt, nickel, or iron.

11. The reciprocating saw blade of claim 1, wherein the cemented ceramic material comprises a hardness of at least 1000 HV10 at room temperature.

12. The reciprocating saw blade of claim 1, wherein the other ceramic particles further comprise particles made of a nitride material.

13. The reciprocating saw blade of claim 1, wherein the plurality of teeth comprises at least 4 teeth per inch along the cutting edge.

14. The reciprocating saw blade of claim 1, wherein each tooth of the plurality of teeth comprises a rake face, a relief face, a point at an intersection between the rake face and the relief face, a gullet, and a protrusion, wherein adjacent teeth of the plurality of teeth are separated by the gullet and the protrusion.

15. The reciprocating saw blade of claim 1, wherein the plurality of teeth further comprise a ceramic coating, the ceramic coating having a thickness of up to 10 μm.

16. The reciprocating saw blade of claim 1, wherein the ceramic coating is applied via physical vapor deposition.

17. The reciprocating saw blade of claim 1, further comprising a plunge point disposed at the second end of the body, wherein the plunge point comprises a leading tooth separated from the plurality of teeth by a leading gullet that spans a greater distance than gullets between adjacent teeth of the plurality of teeth.

18. A method of joining tips comprising a cemented ceramic material to a body of a reciprocating saw blade to form a plurality of teeth, the method comprising:
pressing inserts of the cemented ceramic material against respective bases of the plurality of teeth, the bases being of unitary construction with the body of the reciprocating saw blade;
welding the inserts to the respective bases of the plurality of teeth;
grinding the plurality of teeth to form the tips from the inserts;
wherein the cemented ceramic material comprises tungsten carbide particles and other particles comprising one or more cubic carbides, the tungsten carbide particles and the other particles being held together with a metal matrix material;
wherein the cemented ceramic material comprises at least 3 wt % of the one or more cubic carbides.

19. The method of claim 18, wherein the one or more cubic carbides comprise at least one cubic carbide having a hardness of at least 1500 HV10 and a thermal conductivity of 50 W/mK or less

20. The method of claim 18, wherein the one or more cubic carbides comprise about 12 wt % TiC, about 2 wt % TaC, and about 11 wt % NbC.
